(19) United States
(12) Patent Application Publication
(10) Pub. No.: US 2014/0024242 A1
(43) Pub. Date: Jan. 23, 2014

(54) CONNECTOR TERMINAL

(71) Applicant: YAZAKI CORPORATION, Tokyo (JP)

(72) Inventors: Naokazu NAGASAKA, Makinohara-shi (JP); Takumi Nakagishi, Makinohara-shi (JP)

(73) Assignee: YAZAKI CORPORATION, Tokyo (JP)

(21) Appl. No.: 14/031,629

(22) Filed: Sep. 19, 2013

Related U.S. Application Data
(63) Continuation of application No. PCT/JP2012/055982, filed on Mar. 8, 2012.

(30) Foreign Application Priority Data
Mar. 22, 2011 (JP) 2011-062388

(51) Int. Cl. H01R 13/434

(52) U.S. Cl. CPC H01R 13/434
USPC 439/350

(57) ABSTRACT

A connector terminal which. is accommodated in a terminal chamber in a connector housing and is engaged with a locking lance that is flexibly provided in the terminal chamber includes: a connection portion which is arranged on an opening side of the terminal chamber and is provided in a tubular shape; an engageable opening which is provided on the connection portion, and into which an engagement protrusion in the locking lance is inserted, thus the engageable opening is engaged with the engagement protrusion; and a restriction portion which is provided in the engageable opening, abuts against the engagement protrusion in the locking lance when the connection portion is moved in a direction so as to pall out of the terminal chamber, and which restricts the movement of the engagement protrusion in an insertion-releasing direction relative to the engageable opening.

This application is a continuation of International Application No. PCT/JP2012/055982, filed Mar. 8, 2012, and based upon and claims the benefit of priority from Japanese Patent Application No. 2011-062388, filed Mar. 22, 2011, the entire contents of all of which are incorporated herein by reference.

### BACKGROUND OF THE INVENTION

1. Field of the Invention

The present invention relates to a connector terminal.

2. Description of the Related Art

Conventionally, for a connector terminal which is accommodated in a terminal chamber of a connector housing to engage with an locking lance flexibly provided in the terminal chamber, there is a conventional connector terminal including: a tubular-shaped connection portion which is arranged on an open side of a cavity as the terminal chamber; and an engagement hole as an engageable opening, which is arranged in the connection portion, into which an engagement portion as an engagement protrusion of the locking lance is inserted, and which is provided with an engageable portion to be engaged with the engagement portion (refer to US 2006/0063427 A1).

In the conventional connector terminal, a stabilizer is formed so as to protrude from an exterior face of the connection portion in order to guide an inserting action of the connector terminal through an inserting groove formed in an inner wall of the cavity. In the locking lance, the engagement portion is adapted so as to be engageable with the engageable portion of the connection portion over substantially its whole width. Further, the locking lance is provided, behind the engagement portion and in a portion overlapping with the engagement portion in the width direction, with an escape recess which communicates with the inserting groove to allow an entry of the stabilizer.

### SUMMARY OF TEE INVENTION

The conventional connector terminal would be relatively-advantageous in a case that there exists a space around the locking lance since the engagement portion of the locking lance in the connector housing is adapted so as to be engageable with the engaged portion of the connection portion of the connector terminal over substantially the whole width of the engaged portion.

Reality, however, is that in the conduct of miniaturizing the connector housing, such a space cannot be ensured around the locking lance or the locking lance itself is miniaturized to cause a possibility of reducing a retaining force of the locking lance against the connector terminal.

Therefore, an object of the present invention is to provide a connector terminal which can miniaturize a connector housing and improve a retaining force of an locking lance.

According to a first aspect of the present invention, a connector terminal accommodated in a terminal chamber of a connector housing and engaged with an locking lance flexibly provided in the terminal chamber includes: a connection portion which is arranged on a side of an opening of the terminal chamber and is provided in a square-shaped tube; a square-shaped engageable opening which is provided in one wall of the connection portion so as to communicate an inside of the connection portion with an exterior side thereof, and into which an engagement protrusion in the locking lance is inserted, so that the engageable opening is engaged with the engagement protrusion; and a restriction portion which is provided at a marginal part on one side of the engageable opening, abuts against the engagement protrusion in the locking lance when the connection portion is moved in a direction to pull out from the terminal chamber, and which restricts a movement of the engagement protrusion in an insertion-releasing direction relative to the engageable opening. The restriction portion includes an acute-angled part obtained by forming the marginal part of the engageable opening at a sharp angle. The acute-angled part is adapted so as to bite into the engagement protrusion when the connection portion is moved in a direction to pull out from the terminal chamber.

In the first aspect of the present invention, the connector terminal is provided, in the engageable opening, with the restriction portion which abuts against the engagement protrusion in the locking lance when the connection portion is moved in the direction to pull out from the terminal chamber, and which restricts the movement of the engagement protrusion in the insertion-releasing direction relative to the engageable opening. Thus, even if an external force is applied to the connector terminal in the direction to pull out from the terminal chamber, there is no possibility that the engagement between the engagement protrusion and the engageable opening is released, thus allowing the retaining force of the locking lance against the connector terminal to be improved.

Accordingly, without the need to provide the locking lance of the connector housing with a structure for improving the retaining force against the connector terminal, it is possible to miniaturize the connector housing and also improve the retaining force of the locking lance.

Further, as the restriction portion includes the acute-angled part which is provided by forming the marginal part of the engageable opening at the sharp angle and which can bite into the lance locking face in the engagement protrusion, if an external force is applied to the connector terminal in the direction to pull out from the terminal chamber, then the acute-angled part bites into the engagement protrusion to prevent the engagement between the engagement protrusion and the engageable opening from being cancelled.

The connector terminal according to the first aspect of the present invention may be constructed so that the restriction portion includes a projection portion projecting toward an exterior side of the connection portion.

In this connector terminal, as the projection, portion is formed so as to project toward the exterior side of the connection portion, even if the engagement protrusion in the locking lance tries to move in the insertion-releasing direction relative to the engageable opening, the projection portion would confront in abutting contact with the engagement protrusion, thus preventing the engagement between the engagement protrusion and the engageable opening from being cancelled.

In accordance with the connector terminal according to the first aspect of the present invention, it is possible to achieve an effect of miniaturizing the connector housing as well as improving the retaining force of the locking lance.

### BRIEF DESCRIPTION OF THE DRAWINGS

FIG. 1(a) is a front view of a connector housing in which a connector terminal according to a first embodiment of the present invention is accommodated, and FIG. 1(b) is a sectional view taken along a line of A-A of FIG. 1(a).

FIG. 2(a) is a perspective view of a female terminal as the connector terminal according to the first embodiment of the present invention, FIG. 2(b) is a front view of FIG. 2(a), and FIG. 2(c) is a sectional view taken along a line B-B of FIG. 2(b).

FIG. 3(a) is a perspective view of a male terminal as the connector terminal according to the first embodiment of the present invention, FIG. 3(b) is a front view of FIG. 3(a), and FIG. 3(c) is a sectional view taken along a line C-C of FIG. 3(b).

FIG. 4(a) is a sectional view taken along a line D-D of FIG. 2(c), and FIG. 4(b) is a sectional view of an essential part of the connector terminal accordingto the first embodiment of the present invention.

FIG. 5(a) is a sectional view of a structure where the connector terminal according to the first embodiment of the present invention is accommodated in the connector housing, and FIG. 5(b) is a sectional view of an arrangement where the connector terminal according to the first embodiment of the present invention is moved in its withdrawal direction from terminal chamber.

FIG. 6(a) is a sectional view of an essential part of the connector terminal according to a second embodiment of the present invention, and FIG. 6(b) is a sectional view of an arrangement where the connector terminal according to the second embodiment of the present invention is moved in its withdrawal direction from the terminal chamber.

### DESCRIPTION OF THE EMBODIMENTS

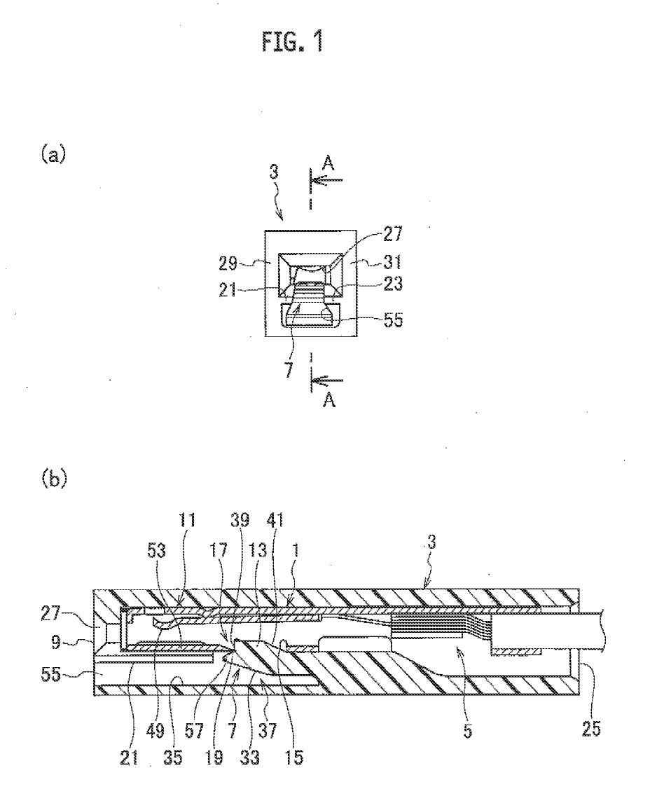

The connector terminals according to embodiments of the present invention will be explained with reference to FIGS. 1 to 6.

### First Embodiment

A connector terminal according to a first embodiment will be explained with reference to FIGS. 1 to 5.

The connecter terminal 1 according to a first embodiment is accommodated in a terminal chamber 5 of a connector housing 3 and is engaged with a locking lance 7 flexibly provided in the terminal chamber 5.

The connector terminal 1 includes a connection portion 11 and an engageable opening 15. The connection portion 11 is arranged on the side of an opening 9 of the terminal chamber 5 and also provided in a tubular shape. The engageable opening 15 is provided on the connection portion 11. An engagement protrusion 13 in the locking lance 7 is inserted into the engageable opening 15 and thus, the engageable opening 15 is engaged with the engagement protrusion 13.

A restriction portion 17 is provided in the engageable opening 15. When the connection portion 11 is moved in the direction so as to pull out of the terminal chamber 5, the restriction portion 17 abuts against the engagement protrusion 13 in the locking lance 7 and restricts the movement of the engagement protrusion 13 in an insertion-releasing direction thereby the engagement protrusion 13 is positioned in the engageable opening 15.

The restriction portion 17 includes an acute-angled part 19 which is obtained by forming a marginal part of the engageable opening 15 to an acute angle and which is provided to bite into the engagement protrusion 13 in the locking lance 7.

It is noted in this embodiment that, in a female connector terminal 1a and a male connector terminal 1b both described later, the female connector terminal 1a is representative of the connector terminal 1.

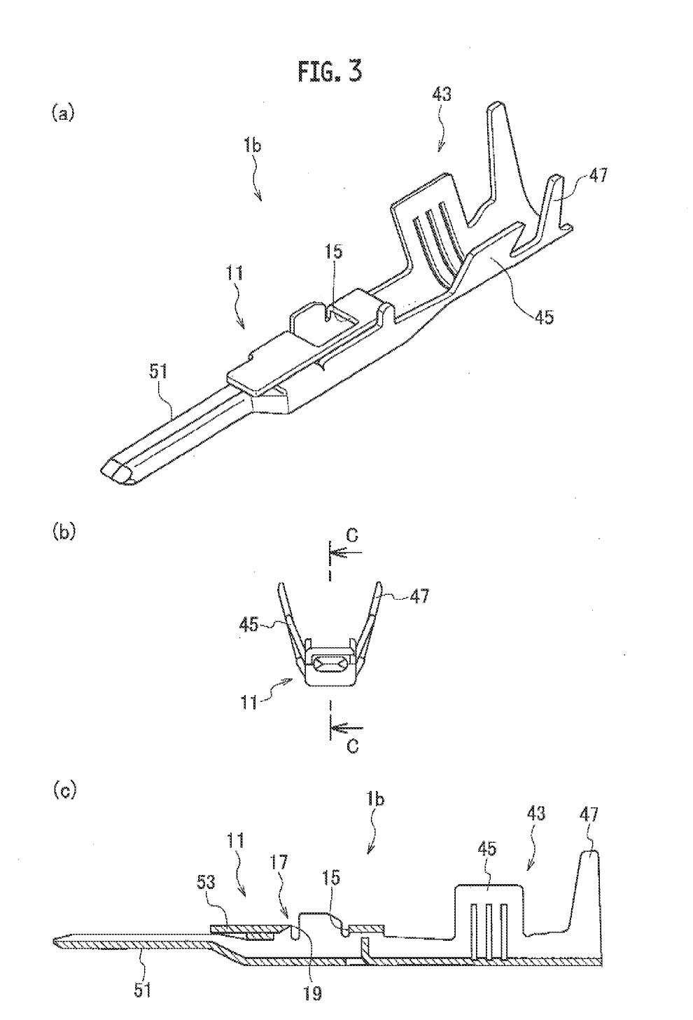

As illustrated in FIG. 1, the connector housing 3 includes the terminal chamber 5, a pair of terminal supporting portions 21, 23 and the locking lance 7. The terminal chamber 5 is formed to extend in the length direction of the connector housing 3 and allow the connector terminal 1 to be inserted from a side of an inserting port 25, so that the connection portion 11 of the connector terminal 1 is arranged on the side of the opening 9. By fitting the connector housing 3 accommodating the connector terminal 1 in the terminal chamber 5 to a mating housing (not illustrated), a tab 51 of the male connector terminal 1b (see FIG. 3) as a mating terminal is inserted through a connection-portion inserting port 27 on the side of the opening 9, so that the connection portion 11 of the connector terminal 1 is connected to the mating terminal. Under condition that the connector terminal 1 is accommodated, in the terminal chamber 5, the connection portion 11 is supported by the pair of terminal supporting portions 21, 23.

The pair of terminal supporting portions 21, 23 are formed so as to extend from both sidewalls 29, 31 of the terminal chamber 5 in the width direction, respectively, and also formed to get close to each other. Further, each of the terminal supporting portions 21, 23 is formed so as to extend from the side of the opening toward the locking lance 7 in the logitudinal direction. Under the condition that the connector terminal 1 is accommodated in the terminal chamber 5, the pair of terminal supporting portions 21, 23 support a bottom face of the connector terminal 1 on both sides of the connection portion 11 in the width direction. The locking lance 7 is positioned on the inserting port 25 side of the terminal chamber 5 to see from the terminal supporting portions 21, 23.

The locking lance 7 is adapted so as to be flexible in a flexible space 37 defined between a lower face 33 of the locking lance 7 and an inner wail 35 of the terminal chamber 35. The locking lance 7 is provided with the engagement protrusion 13. The engagement protrusion 13 has a lance locking face 39 formed so as to prodrude upward in a flexing direction. When the connector terminal 1 is accommodated in the terminal chamber 5 through the inserting port 25, the locking lance 7 is deflected downwardly since an inclined face 41 abuts against a front end of the connector terminal 1. From, this state, when the connection portion 11 of the connector terminal 1 is supported by the pair of terminal supporting portions 21, 23 as a result of further inserting the connector terminal 1 toward the opening 9, the locking lance 7 is restored upwardly. Then, the engagement protrusion 13 is inserted into the engageable opening 15 of the connector terminal 1, thus preventing the connector terminal 1 from pulling out from the terminal chamber 5.

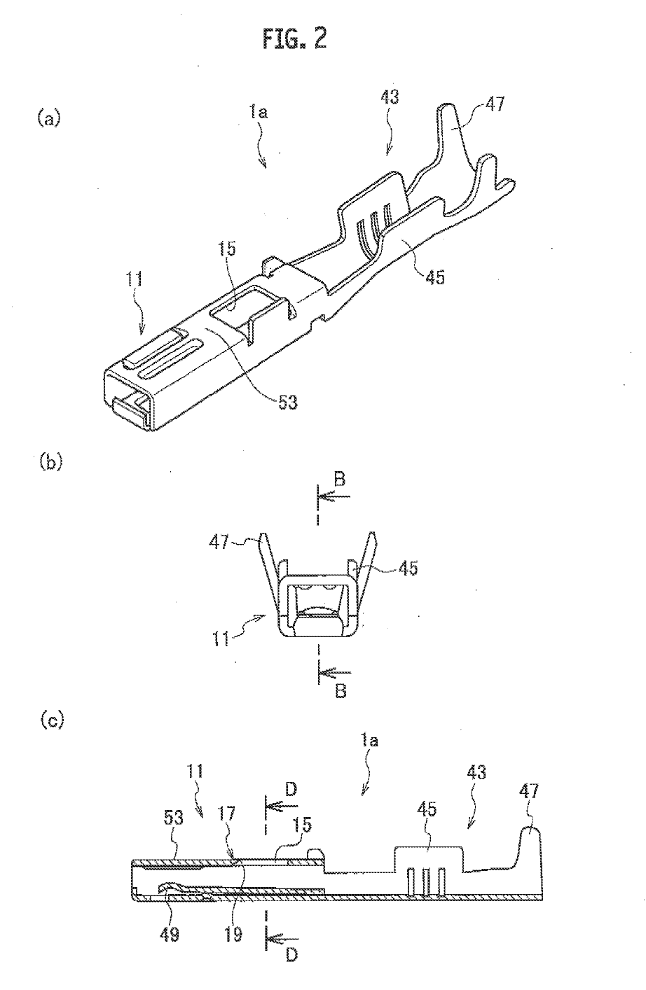

As illustrated in FIGS. 2 and 3, the connector terminal 1 is made from conductive material and includes the female connector terminal 1a and the male connector terminal 1b. Each of the female connector terminal 1a and the male connector terminal 1b includes a wire fixing portion 43, the connection portion 11 and the engageable opening 15. The wire fixing portion 43 includes a core fixing portion 45 for crimping a core line of a covered wire (not illustrated) in electrical conduction and a cover fixing portion 47 for crimping a cover of the covered wire thereby fixing the covered wire. Since the covered wire is fixed to the wire fixing portion 43, the electrical connection between an electronic component etc. (not illustrated) connected to the covered wire and the connector terminal 1 can be effected.

The connection portion 11 is formed to be a square-shaped tube. The connection portion 11 of the female connector terminal 1a contains an inside spring 49 capable of elastic deformation. While, the connection portion 11 of the male connector terminal 1b includes the tab 51 capable of being inserted into the connection-portion inserting port 27 of the connector housing 3. By inserting the tab 51 of the male connector terminal 1b into the connection portion 11 of the female connector terminal 1a, the spring 49 comes into elastic contact with the tab 31. As a result, the female connector terminal 1a and the male connector terminal 1b are electrically connected to each other. The connection portion 11 is provided with the engageable opening 15 consisting of a lance hole for locking the connector terminal 1 within the terminal chamber 5.

Note, the following description about the engageable opening 15 is based on the assumption that the connector terminal 1 is the female connector terminal 1a. Nevertheless, even if the male connector terminal 1b is representative of the connector terminal 1, the engageable opening 15 of the male connector terminal 1b would function in the same way as that of the female connector terminal 1a, thereby achieving the similar effect as well.

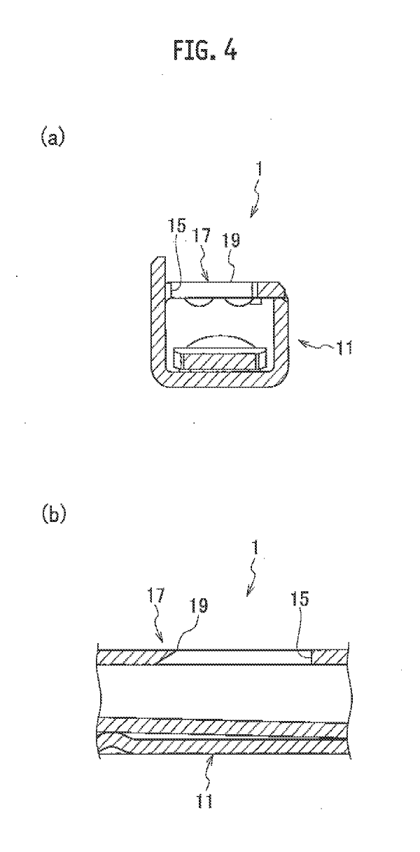

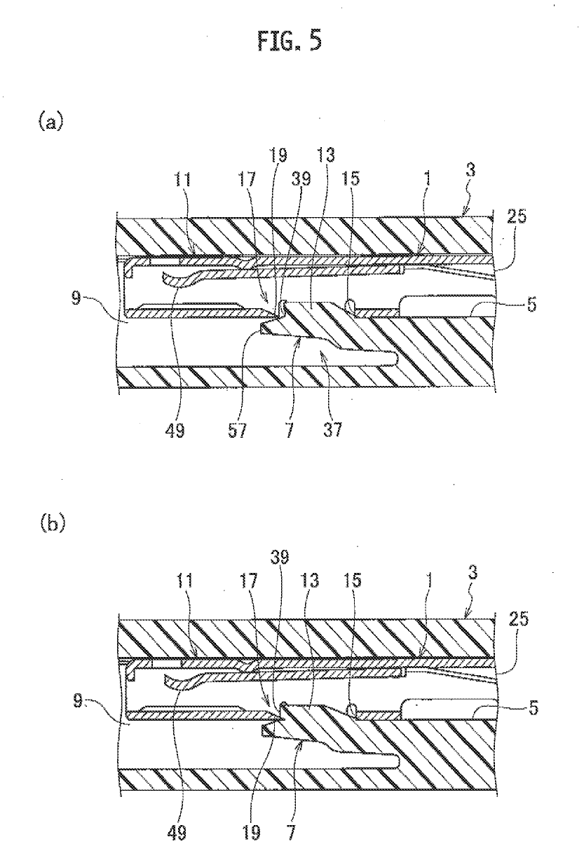

As illustrated in FIGS. 4 and 5, the engageable opening 15 is formed in a wall part 53 of the connection portion 11 so as to communicate an inside of the connection portion 11 with an exterior side of the connection portion 11. With the engagement protrusion 13 in the locking lance 7 inserted, if an external force directing to inserting port 25 is applied to the connector terminal 1 in the direction to pull out from the terminal chamber 5, then the marginal part of the engageable opening 15 abuts against the lance locking face 39 of the engagement protrusion 13, thus preventing the connector terminal 1 from being pulled out from terminal chamber 5. The restriction portion 17 is arranged at the marginal part of the engageable opening 15.

The restriction portion 17 includes the acute-angled part 19 where the marginal part of the engageable opening 15 abutting against the lance locking face 39 in the engagement protrusion 13 is shaped at a sharp angle. When the connection portion 11 of the connector terminal 1 is moved in the direction to pull out from the terminal chamber 5, the acute-angled part 19 bites into the lance locking face 39 of the engagement protrusion 13. With the acute-angled part 19 biting into the lance looking face 39, the engagement protrusion 13 is restrained from being moved from the engageable opening 15 in the insertion-releasing direction. Consequently, cancelling of the engagement between the engagement protrusion 13 and the engageable opening 15 is prevented.

Assume, the marginal part of the engageable opening 15 for contact with the lance locking face 39 is flat-shaped since the marginal part is either unprocessed or chamfered in such a case, if an external force directing to inserting port 25 is applied to the connector terminal 1 in the direction to pull out from the terminal chamber 5, shearing is initiated at the marginal part of the engageable opening 15, horizontally or at an upward angle (i.e. direction to the interior side of the connection portion 11). For this reason, since the acute-angled part 19 is formed by the marginal part of the engageable opening 15 whose underside end is shaped at the sharp angle, the acute-angled part 19 bites into the lance locking face 39 due to the initiation of shearing, allowing the acute-angled part 19 to bite into a deeper portion of the engagement protrusion 13. By the acute-angled part 19, the shearing distance between marginal part of the engageable opening 15 and the lance locking face 39 of the engagement protrusion 13 can be lengthened under condition that the engagement protrusion 13 is inserted into the engageable opening 15, allowing the shearing strength, that is retaining force of the locking lance 7 against the connector terminal 1 to he improved.

In order to cancel the engagement between the engagement protrusion 13 of the locking lance 7 and the engageable opening 15 of the connector terminal 1, it is performed to move the connector terminal 1 toward the opening 9, so that one state of FIG. 5(b) where the acute-angled part 19 bites into the engagement protrusion 13 changes to another state of FIG. 5(a) where the biting of the acute-angled part 19 into the engagement protrusion 13 is released. Next, a release jig (not illustrated) is inserted into the connector housing 3 through a jig inserting port 55 on the side of the opening 9 to abut against a jig releasing portion 57 funned at the tip of the locking lance 7, thus flexing the locking lance 7 downwardly. With this downward flexing of the locking lance 7, the engagement between the engagement protrusion 13 and the engageable opening 15 is cancelled to allow the connector terminal 1 to be taken out of the terminal chamber 5.

In this way the connector terminal 1 is provided, in the engageable opening 15, with the restriction portion 17 which abuts against the engagement protrusion 13 in the locking lance 7 when the connection portion 11 is moved in the direction to pull out from the terminal chamber 5, and which restricts the movement of engagement protrusion 13 in the insertion-releasing direction relative to the engageable opening 15. For this reason, even if an external force is applied to the connector terminal 1 in the direction to pull out from the terminal chamber 5, there is no possibility that the engagement between the engagement protrusion 13 and the engageable opening 15 is released, thus allowing the retaining force of the locking lance 7 against the connector terminal 1 to be improved.

Accordingly, without the need to provide the locking lance 7 of the connector housing 3 with a structure for improving the retaining force against the connector terminal 1, it is possible to miniaturize the connector housing 3 and also improve the retaining force of the locking lance 7.

Additionally, the restriction portion 17 includes the acute-angled part 19 which is provided by forming the marginal part of the engageable opening 15 at the sharp angle and which abuts against the lance locking face 39 in the engagement protrusion 13. Therefore, if an external force is applied to the connector terminal 1 in the direction to pull out from the terminal chamber 5, then the acute-angled part 19 bites into the engagement protrusion 13 to prevent the engagement between the engagement protrusion 13 and the engageable opening 15 from being cancelled.

### Second Embodiment

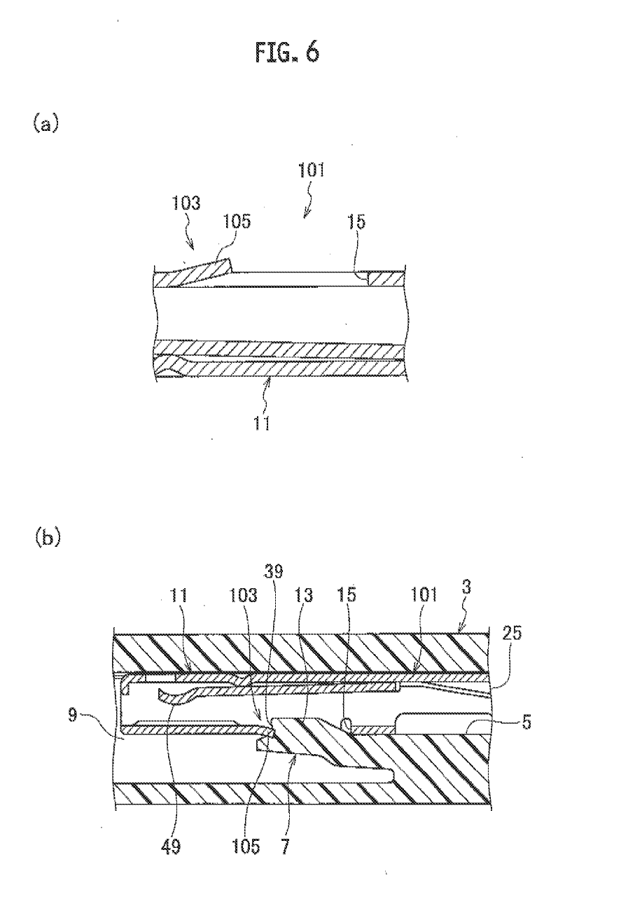

A connector terminal 101 according to a second embodiment of the present invention will be explained with reference to FIG. 6.

In the connector terminal 101 according to the second embodiment, a restriction portion 103 includes a pvojection portion 105 projecting toward as outside of the tubular connection portion 11. Note, elements identical to those of the first embodiment are respectively indicated with the same reference numerals and their descriptions are omitted. For a certain constitution identical to that of the first embodiment, although its description in terms of its function could be omitted by reference to that of the first embodiment, it is noted that its effect is the same as that of the first embodiment.

As illustrated in FIG. 6, the restriction portion 103 includes the projection portion 105 where a marginal part of the engageable opening 15 abutting against the lance locking face 39 of the engagement protrusion 13 projects toward the outside of the tubular connection portion 11. A projecting direction of the projection portion 105 coincides with the insertion-releasing direction to cancel the insertion of the engagement protrusion 13 of the locking lance 7 into the engageable opening 15. Now as mentioned above if an external force directing to inserting port 25 is applied to the connector terminal 101 in the direction to pall oat from the terminal chamber 5, shearing is initiated between the engagement protrusion 13 and the marginal part of the engageable opening 15, horizontally or at an upward angle (i.e. direction to the interior side of the connection portion 11). For this reason, since the projection portion 105 projects toward the exterior side of the connection portion 11, the tip of the projection portion 105 bites into the lance locking face 39 due to the initiation of shearing, allowing the tip of the projection portion 105 to bite into a deeper portion of the engagement protrusion 13. Thus, owing to the provision of the projection portion 105, it is possible to improve the retaining force of the locking lance 7 against the connector terminal 101.

In this way, as the connector terminal 101 has the projection portion 105 formed so as to project toward the exterior side of the connection portion 11, even if the engagement protrusion 13 in the locking lance 7 tries to move in the insertion-releasing direction relative to the engageable opening 15, the projection portion 105 would confront in abutting contact with the engagement protrusion 13, thus preventing the engagement between the engagement protrusion 13 and the engageable opening 15 from being cancelled.

In the connector terminal according to this embodiment of the present invention, although the restriction portion has the projection portion whose tip is flattened, the tip of the projection pardon may be formed with an acute angle to provide an acute-angled part. In such a case, when an external force is applied to the connector terminal in the direction to pull out from the terminal chamber, the acute-angled part at the tip of the projection portion would bite into the engagement protrusion of the locking lance, allowing the retaining force of the locking lance against the connector terminal to be improved furthermore.

What is claimed is:

1. A connector terminal accommodated in a terminal chamber of a connector housing and engaged with an locking lance flexibly provided in the terminal chamber, comprising:
a connection portion which is arranged on a side of an opening of the terminal chamber and is provided in a square-shaped tube;
a square-shaped engageable opening which is provided in one wall of the connection portion so as to communicate an inside of the connection portion with an exterior side thereof, and into which an engagement protrusion in the locking lance is inserted, so that the engageable opening is engaged with the engagement protrusion; and
a restriction portion which is provided at a marginal part on one side of the engageable opening, abuts against the engagement protrusion in the locking lance when the connection portion is moved in a direction to pull out from the terminal chamber, and which restricts a movement of the engagement protrusion in an insertion-releasing direction relative to the engageable opening, wherein
the restriction portion includes an acute-angled part obtained by forming the marginal part of the engageable opening at a sharp angle, and
the acute-angled part is adapted so as to bite into the engagement protrusion when the connection portion is moved in a direction to pull out from the terminal chamber.

2. The connector terminal of claim 1, wherein
the restriction portion includes a projection portion projecting toward an exterior side of the connection portion.
